(19) United States
(12) Patent Application Publication
(10) Pub. No.: US 2025/0321526 A1
(43) Pub. Date: Oct. 16, 2025

(54) IMAGE FORMING APPARATUS AND IMAGE FORMING METHOD

(71) Applicant: Yoshiki HOZUMI, Kanagawa (JP)

(72) Inventor: Yoshiki HOZUMI, Kanagawa (JP)

(73) Assignee: Ricoh Company, Ltd., Tokyo (JP)

(21) Appl. No.: 19/085,268

(22) Filed: Mar. 20, 2025

(30) Foreign Application Priority Data
Apr. 15, 2024 (JP) 2024-065244
Feb. 6, 2025 (JP) 2025-018281

(51) Int. Cl. G03G 15/00; G03G 15/01

(52) U.S. Cl. CPC G03G 15/5037; G03G 15/0189; G03G 15/5041; G03G 2215/00042

(57) ABSTRACT

An image forming apparatus includes an image bearer and a primary transferor to be applied with a primary transfer voltage. The primary transferor is disposed opposite the image bearer via an intermediate transferor to form a primary transfer portion where the primary transferor transfers a toner image formed on the image bearer onto the intermediate transferor. A primary transfer electric current detector detects an electric current value of an electric current supplied to the primary transferor. A control-input device receives intermediate transferor replacement data that indicates that the intermediate transferor is replaced. A controller performs a primary transfer voltage determination control that determines the primary transfer voltage based on the detected electric current value and performs the primary transfer voltage determination control at a time when the control-input device receives the intermediate transferor replacement data and a time after an initial image formation after the intermediate transferor is replaced.

### CROSS-REFERENCE TO RELATED APPLICATIONS

This patent application is based on and claims priority pursuant to 35 U.S.C. § 119(a) to Japanese Patent Application Nos. 2024-065244, filed on Apr. 15, 2024, and 2025-018281, filed on Feb. 6, 2025, in the Japan Patent Office, the entire disclosure of each of which is hereby incorporated by reference herein.

### BACKGROUND

### Technical Field

Embodiments of this disclosure relate to an image forming apparatus and an image forming method.

### Related Art

Related-art image forming apparatuses, such as copiers, facsimile machines, printers, and multifunction peripherals (MFP) having two or more of copying, printing, scanning, facsimile, plotter, and other functions, typically form an image on a recording medium according to image data.

Such image forming apparatuses include a primary transferor that is applied with a primary transfer voltage and primarily transfers a toner image formed on an image bearer onto an intermediate transferor at a primary transfer portion. A primary transfer electric current detector detects an electric current value of an electric current supplied to the primary transferor. A controller performs a primary transfer voltage determination control that determines the primary transfer voltage based on the detected electric current value. A control-input device receives an instruction from a user. As the user inputs intermediate transferor replacement data by using the control-input device, the controller performs the primary transfer voltage determination control.

### SUMMARY

This specification describes below an improved image forming apparatus. In one embodiment, the image forming apparatus includes an image bearer that bears a toner image and a primary transferor to be applied with a primary transfer voltage. The primary transferor is disposed opposite the image bearer via an intermediate transferor to form a primary transfer portion where the primary transferor primarily transfers the toner image formed on the image bearer onto the intermediate transferor. A primary transfer electric current detector detects an electric current value of an electric current supplied to the primary transferor. A control-input device receives intermediate transferor replacement data that indicates that the intermediate transferor is replaced. A controller performs a primary transfer voltage determination control that determines the primary transfer voltage based on the detected electric current value. The controller performs the primary transfer voltage determination control at a time when the control-input device receives the intermediate transferor replacement data and a time after an initial image formation after the intermediate transferor is replaced.

This specification further describes an improved image forming apparatus. In one embodiment, the image forming apparatus includes an image bearer that bears a toner image and a primary transferor to be applied with a primary transfer voltage. The primary transferor is disposed opposite the image bearer via an intermediate transferor to form a primary transfer portion where the primary transferor primarily transfers the toner image formed on the image bearer onto the intermediate transferor. A primary transfer electric current detector detects an electric current value of an electric current supplied to the primary transferor. A control-input device receives intermediate transferor replacement data that indicates that the intermediate transferor is replaced. An image density detector detects an image density of the toner image borne on one of the image bearer and the intermediate transferor. A controller performs a primary transfer voltage determination control that determines the primary transfer voltage based on the detected electric current value. The controller performs an image density adjustment control that adjusts an image forming condition under which the toner image is formed on the image bearer based on the image density detected by the image density detector at an interval smaller than an interval at which the controller performs the primary transfer voltage determination control. The controller performs the primary transfer voltage determination control at a time when the control-input device receives the intermediate transferor replacement data and a time when the controller finishes the image density adjustment control performed initially after the intermediate transferor is replaced.

This specification further describes an improved image forming method. In one embodiment, the image forming method includes resetting a counter value counted from start of usage of an intermediate transferor, detecting an electric current value of an electric current supplied to a first primary transferor, calculating a primary transfer voltage to be applied to the first primary transferor and a second primary transferor based on the detected electric current value, starting printing, finishing printing, detecting the electric current value of the electric current supplied to the first primary transferor, calculating the primary transfer voltage to be applied to the first primary transferor and the second primary transferor based on the detected electric current value.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic cross-sectional view of an image forming apparatus according to an embodiment of the present disclosure, as a printer as one example of the image forming apparatus;

FIG. 2 is a block diagram of the image forming apparatus depicted in FIG. 1, illustrating a hardware configuration thereof;

FIG. 3 is a block diagram of the image forming apparatus depicted in FIG. 1, illustrating a functional configuration thereof, as one example;

FIG. 4 is a block diagram of an image forming apparatus according to an embodiment of the present disclosure, illustrating a functional configuration thereof, as another example;

FIG. 5 is a graph illustrating a relation between a primary transfer voltage and a transfer rate of the image forming apparatus depicted in FIG. 1;

FIG. 6 is a graph illustrating a relation between a surface resistivity of an intermediate transfer belt and an electric current supplied to a primary transfer roller, that is detected by a detector incorporated in the image forming apparatus depicted in FIG. 1;

FIG. 7 is a bias table used to determine the primary transfer voltage based on the electric current detected by the detector depicted in FIG. 1, as one example;

FIG. 8 is a graph illustrating a transformation formula used by the image forming apparatus depicted in FIG. 2;

FIG. 9 is a graph illustrating a plurality of transformation formulas used by the image forming apparatus depicted in FIG. 2;

FIG. 10 is a flowchart of a primary transfer voltage determination control performed by the image forming apparatus depicted in FIG. 3;

FIG. 11 is a flowchart of the primary transfer voltage determination control performed by the image forming apparatus depicted in FIG. 3 when an intermediate transfer unit incorporated in the image forming apparatus is replaced; and

FIG. 12 is a flowchart of the primary transfer voltage determination control performed by the image forming apparatus depicted in FIG. 4 again after an initial process control after the intermediate transfer unit is replaced.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The following describes embodiments of the present disclosure with reference to drawings. One skilled in the art may change and modify the embodiments of the present disclosure to other embodiments within the scope of the present disclosure readily. The scope of the present disclosure encompasses such change and modification. The following describes the embodiments of the present disclosure, that do not limit the scope of the present disclosure.

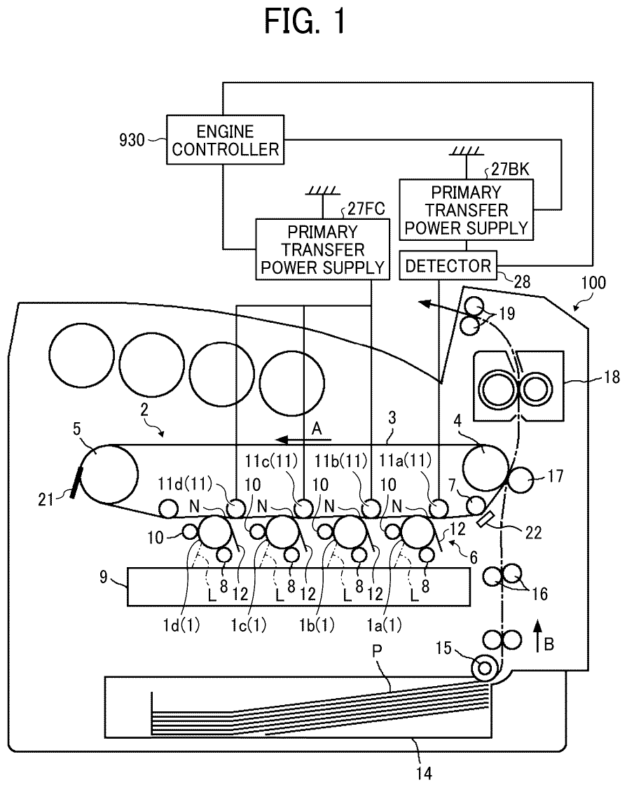

FIG. 1 is a schematic cross-sectional view of an image forming apparatus 100 as a printer as one example of the image forming apparatus 100.

The image forming apparatus 100 depicted in FIG. 1 includes four image bearers, that is, photoconductors 1a, 1b, 1c, and 1d serving as a first image bearer, a second image bearer, a third image bearer, and a fourth image bearer, respectively, that are disposed inside a body of the image forming apparatus 100. Each of the photoconductors 1a, 1b, 1c, and 1d is hereinafter referred to as a photoconductor 1 properly in a case that the photoconductor 1 does not specify a color. The photoconductors 1a, 1b, 1c, and 1d bear toner images in different colors, respectively. For example, the photoconductors 1a, 1b, 1c, and 1d bear a black toner image, a magenta toner image, a cyan toner image, and a yellow toner image, respectively. Each of the photoconductors 1a, 1b, 1c, and 1d depicted in FIG. 1 is drum-shaped. Alternatively, the image forming apparatus 100 may employ a photoconductor as an endless belt that is looped over a plurality of rollers and is driven and rotated.

The image forming apparatus 100 further includes an intermediate transfer belt 3 serving as an intermediate transferor that is disposed opposite the photoconductors 1a, 1b, 1c, and 1d as the first photoconductor, the second photoconductor, the third photoconductor, and the fourth photoconductor, respectively. Each of the photoconductors 1a, 1b, 1c, and 1d contacts an outer circumferential surface of the intermediate transfer belt 3, forming a primary transfer portion N (e.g., a primary transfer nip) therebetween. The black, magenta, cyan, and yellow toner images primarily transferred from the photoconductors 1a, 1b, 1c, and 1d, respectively, onto the intermediate transfer belt 3 are secondarily transferred onto a transfer material (e.g., a recording medium P).

The image forming apparatus 100 further includes a driving roller 4, a tension roller 5, and an entrance roller 7 serving as support rollers around which the intermediate transfer belt 3 is wound. One of the support rollers, for example, the driving roller 4, is driven by a driver. The driving roller 4 drives and rotates the intermediate transfer belt 3 in a rotation direction A.

The intermediate transfer belt 3 may have a layer structure constructed of multiple layers or a layer structure constructed of a single layer. In a case that the intermediate transfer belt 3 is constructed of the multiple layers, the intermediate transfer belt 3 preferably includes a base layer and a coating layer. For example, the base layer is made of fluororesin, a polyvinylidene fluoride (PVDF) sheet, or polyimide resin that is stretch resistant. The coating layer serves as a surface layer that covers the base layer. The coating layer is preferably made of fluororesin or the like and has smoothness. In a case that the intermediate transfer belt 3 is constructed of the single layer, the intermediate transfer belt 3 is made of PVDF, polycarbonate (PC), polyimide, or the like.

The image forming apparatus 100 further includes primary transfer rollers 11a, 11b, 11c, and 11d serving as primary transferors that are disposed within a loop formed by the intermediate transfer belt 3 and are substantially disposed opposite the photoconductors 1a, 1b, 1c, and 1d, respectively, via the intermediate transfer belt 3. Each of the primary transfer rollers 11a, 11b, 11c, and 11d is hereinafter referred to as a primary transfer roller 11 properly in a case that the primary transfer roller 11 does not specify a color. Each of the primary transfer rollers 11a, 11b, 11c, and 11d contacts an inner circumferential surface (e.g., a back face) of the intermediate transfer belt 3, properly forming the primary transfer portion N (e.g., the primary transfer nip) between each of the photoconductors 1a, 1b, 1c, and 1d and the intermediate transfer belt 3. The primary transfer roller 11 is made of metal.

The primary transfer roller 11 contacts the inner circumferential surface of the intermediate transfer belt 3 such that the primary transfer portion N serving as a contact region where the photoconductor 1 contacts the intermediate transfer belt 3 does not overlap a contact region where the primary transfer roller 11 contacts the intermediate transfer belt 3 in the rotation direction A (e.g., a moving direction) thereof in an indirect transfer method. According to the embodiment, a distance (e.g., an offset amount) on the intermediate transfer belt 3, that is between the photoconductor 1 and the primary transfer roller 11 and for which the intermediate transfer belt 3 does not contact the photoconductor 1 and the primary transfer roller 11, is in a range of from 4 mm to 5 mm.

As described above, the image forming apparatus 100 employs the indirect transfer method in which the primary transfer portion N does not overlap the contact region where the primary transfer roller 11 contacts the intermediate transfer belt 3 in the rotation direction A of the intermediate transfer belt 3. Accordingly, the primary transfer roller 11 is made of metal having an electric resistance that increases in a decreased amount over time.

The image forming apparatus 100 has a substantially identical construction that forms the black, magenta, cyan, and yellow toner images on the photoconductors 1a, 1b, 1c, and 1d, respectively, and transfers the black, magenta, cyan, and yellow toner images onto the intermediate transfer belt 3 although the black, magenta, cyan, and yellow toner images are different in color. Hence, the following describes a construction and operation that form a black toner image on the photoconductor 1a as the first photoconductor and transfer the black toner image onto the intermediate transfer belt 3. The photoconductor 1a is driven and rotated clockwise in FIG. 1. The image forming apparatus 100 further includes a discharger that irradiates a surface of the photoconductor 1a with light, initializing a surface potential of the photoconductor 1a.

The image forming apparatus 100 further includes chargers 8 and an exposure device 9. The charger 8 uniformly charges the surface of the photoconductor 1a having the initialized surface potential at a predetermined polarity, for example, a negative polarity. The exposure device 9 irradiates the charged surface of the photoconductor 1a with a laser beam L that is optically modulated, forming an electrostatic latent image on the surface of the photoconductor 1a according to writing data (e.g., image data). The image forming apparatus 100 depicted in FIG. 1 employs the exposure device 9 as a laser writer that emits the laser beams L. Alternatively, the image forming apparatus 100 may employ an exposure device or the like that includes a light-emitting diode (LED) array and an imaging device.

The image forming apparatus 100 further includes developing devices 10. While the electrostatic latent image formed on the photoconductor 1a passes through a position disposed opposite the developing device 10, the developing device 10 visualizes the electrostatic latent image into a black toner image. The primary transfer roller 11a is applied with a primary transfer voltage having a polarity opposite to a polarity of charged toner of the black toner image formed on the photoconductor 1a, that is, a positive polarity, for example. Thus, a primary transfer electric field generates at the primary transfer portion N between the photoconductor 1a and the intermediate transfer belt 3. Accordingly, the primary transfer roller 11a primarily transfers the black toner image formed on the photoconductor 1a electrostatically onto the intermediate transfer belt 3 driven and rotated synchronously with rotation of the photoconductor 1a at the primary transfer portion N where the photoconductor 1a contacts the outer circumferential surface of the intermediate transfer belt 3. The image forming apparatus 100 further includes cleaners 12. The cleaner 12 removes residual toner, that is failed to be transferred onto the intermediate transfer belt 3 and is therefore adhered to and remaining on the surface of the photoconductor 1a after the primary transfer roller 11a transfers the black toner image onto the intermediate transfer belt 3, from the photoconductor 1a, thus cleaning the surface of the photoconductor 1a.

Similarly, the primary transfer rollers 11b, 11c, and 11d electrostatically transfer the magenta, cyan, and yellow toner images formed on the photoconductors 1b, 1c, and 1d serving as the second photoconductor, the third photoconductor, and the fourth photoconductor, respectively, onto the intermediate transfer belt 3 transferred with the black toner image such that the magenta, cyan, and yellow toner images are superimposed on the black toner image successively.

The image forming apparatus 100 provides two modes, that is, a full color mode using toners in four colors and a monochrome black mode using a black toner. In the full color mode, the intermediate transfer belt 3 contacts the photoconductors 1a, 1b, 1c, and 1d bearing the black, magenta, cyan, and yellow toner images, respectively, to be transferred onto the intermediate transfer belt 3. Conversely, in the monochrome black mode, the intermediate transfer belt 3 contacts the photoconductor 1a bearing the black toner image to be transferred onto the intermediate transfer belt 3. The intermediate transfer belt 3 does not contact the photoconductors 1b, 1c, and 1d bearing the magenta, cyan, and yellow toner images, respectively. The image forming apparatus 100 further includes a separator that separates the primary transfer rollers 11b, 11c, and 11d from the photoconductors 1b, 1c, and 1d, respectively.

The image forming apparatus 100 further includes a sheet feeder 14, a feed roller 15, a registration roller pair 16, and a secondary transfer roller 17. The sheet feeder 14 is disposed in a lower portion of the body of the image forming apparatus 100 and loads a plurality of recording media P (e.g., transfer sheets). As the feed roller 15 rotates, the feed roller 15 feeds a recording medium P serving as a transfer material from the sheet feeder 14 in a recording medium conveyance direction B to the registration roller pair 16. The registration roller pair 16 feeds the recording medium P fed by the feed roller 15 to a secondary transfer portion (e.g., a secondary transfer nip) at a predetermined time. The secondary transfer portion is formed between a transfer portion of the intermediate transfer belt 3, that is looped over the driving roller 4, and the secondary transfer roller 17 serving as one example of a transfer device disposed opposite the transfer portion of the intermediate transfer belt 3. The secondary transfer roller 17 is applied with a predetermined transfer voltage, thus secondarily transferring a composite toner image (e.g., a full color toner image), that is formed by the black, magenta, cyan, and yellow toner images on the intermediate transfer belt 3, onto the recording medium P.

The image forming apparatus 100 further includes a fixing device 18 and an output roller pair 19. The secondary transfer roller 17 conveys the recording medium P secondarily transferred with the composite toner image upward to the fixing device 18. While the recording medium P passes through the fixing device 18, the fixing device 18 fixes the composite toner image on the recording medium P under heat and pressure. After the recording medium P passes through the fixing device 18, the output roller pair 19 disposed in an output portion of the image forming apparatus 100 ejects the recording medium P onto an outside of the image forming apparatus 100.

The image forming apparatus 100 further includes a belt cleaner that removes residual toner adhered to and remaining on the intermediate transfer belt 3 after the secondary transfer roller 17 transfers the composite toner image onto the recording medium P. The belt cleaner according to the embodiment includes a cleaning blade 21 that is blade-shaped and made of urethane or the like. The cleaning blade 21 contacts the intermediate transfer belt 3 in a direction counter to the rotation direction A of the intermediate transfer belt 3. Alternatively, as being obvious to one skilled in the art, the image forming apparatus 100 may employ belt cleaners of various types properly. For example, the image forming apparatus 100 may employ a capacitive cleaner employing an electrostatic capacity method.

The belt cleaner further includes a cleaning case and a waste toner coil disposed inside the cleaning case. The waste toner coil conveys the residual toner removed by the cleaning blade 21 from the intermediate transfer belt 3 to a rear of the cleaning case in a longitudinal direction of the waste toner coil. The image forming apparatus 100 further includes a waste toner conveyance path and a waste toner container that are disposed inside the body of the image forming apparatus 100. The residual toner passes through the waste toner conveyance path and is conveyed to the waste toner container.

The image forming apparatus 100 further includes an intermediate transfer unit 2 and an image forming device 6. The intermediate transfer unit 2 includes the intermediate transfer belt 3, the primary transfer rollers 11a, 11b, 11c, and 11d, the cleaning blade 21, the driving roller 4, the tension roller 5, and the entrance roller 7. The image forming device 6 includes the photoconductor 1, the charger 8, the exposure device 9, the developing device 10, and the cleaner 12.

The image forming apparatus 100 according to the embodiment performs a process control serving as an image density adjustment control to improve image density of each of the black, magenta, cyan, and yellow toner images whenever a predetermined number of pages of the recording media P is printed. The predetermined number of pages printed is in a range of from 30 pages to 200 pages. In the process control, a gradation pattern for each color (e.g., black, magenta, cyan, and yellow), that includes a plurality of toner patches having different toner adhesion amounts of black, magenta, cyan, and yellow toners, respectively, is formed on the intermediate transfer belt 3. When the gradation pattern is formed, a charging bias and a developing bias are switched successively at appropriate times, thus forming the gradation pattern including the plurality of toner patches having the different adhesion amounts of the black, magenta, cyan, and yellow toners, respectively. The image forming apparatus 100 further includes an optical sensor 22 serving as an image density detector. As the intermediate transfer belt 3 rotates endlessly, the gradation pattern formed on the intermediate transfer belt 3 passes through an opposed position disposed opposite the optical sensor 22. The optical sensor 22 receives light in an amount corresponding to the toner adhesion amount per unit area for each of the toner patches of the gradation pattern.

Although a detailed description is omitted, based on an output voltage from the optical sensor 22 that detects each of the toner patches and an adhesion amount conversion algorithm, the toner adhesion amount of each of the toner patches of the gradation pattern for each of the black, magenta, cyan, and yellow toners is calculated. Based on the calculated toner adhesion amount, an image forming condition is adjusted. For example, based on a detection result of the toner adhesion amount of the toner patch and a developing potential with which each of the toner patches is formed, a linear function (y=ax+b) representing a current developing capability is calculated with regression analysis. A target value of an image density is substituted into the linear function to calculate an appropriate developing bias value and specify exposure power, a charging bias, and a developing bias for each of the black, magenta, cyan, and yellow toner images as an image forming condition. In a case that the developing device 10 employs a two-component developing method using a two-component developer containing toner and carriers, a toner density control target value of the toner inside the developing device 10 is changed to control an image density. For example, based on a detection result provided by the optical sensor 22, the toner density control target value of the toner inside the developing device 10 is changed to adjust a maximum target toner adhesion amount (e.g., a toner adhesion amount to obtain a target identifier (ID)) to a target value.

Alternatively, the optical sensor 22 may be disposed opposite each of the photoconductors 1a, 1b, 1c, and 1d so that the optical sensor 22 detects a toner pattern formed on each of the photoconductors 1a, 1b, 1c, and 1d.

FIG. 1 illustrates an example of a diagram of an applied power supply used in the image forming apparatus 100 according to the embodiment.

The image forming apparatus 100 further includes primary transfer power supplies 27BK and 27FC, a detector 28, and an engine controller 930. The primary transfer power supply 27BK, that applies a voltage to the primary transfer roller 11a to transfer the black toner image, is connected to the detector 28 serving as a primary transfer electric current detector and the engine controller 930 serving as a controller. The detector 28 is connected to the primary transfer power supply 27BK for the black toner image, the primary transfer roller 11a for the black toner image, and the engine controller 930. The detector 28 serves as the primary transfer electric current detector that detects an amount of an electric current supplied to the primary transfer roller 11a when the primary transfer power supply 27BK applies a bias to the primary transfer roller 11a for the black toner image. The primary transfer power supply 27FC for the full color toner image applies a bias to each of the primary transfer rollers 11b, 11c, and 11d. The primary transfer power supply 27FC for the full color toner image is connected to the engine controller 930.

The engine controller 930 determines a primary transfer voltage to be applied to each of the primary transfer rollers 11a, 11b, 11c, and 11d based on a detection result provided by the detector 28, that is, an electric current value detected by the detector 28.

According to the embodiment, the detector 28 is connected to the primary transfer roller 11a disposed opposite the photoconductor 1a that bears the black toner image. The detector 28 detects the amount of the electric current supplied to the primary transfer roller 11a based on which the engine controller 930 determines the primary transfer voltage to be applied to each of the primary transfer rollers 11a, 11b, 11c, and 11d. Accordingly, the image forming apparatus 100 incorporates the single detector 28, reducing costs of the intermediate transfer unit 2 and a resistance detector.

As described above, in the monochrome black mode, the separator moves and separates the primary transfer rollers 11b, 11c, and 11d used for forming the full color toner image from the photoconductors 1b, 1c, and 1d, respectively. Conversely, the primary transfer roller 11a used for forming the black toner image is disposed at an identical position constantly, stabilizing a positional relation between the intermediate transfer belt 3 and the photoconductor 1a used for forming the black toner image, that contacts the intermediate transfer belt 3, and a positional relation between the intermediate transfer belt 3 and the primary transfer roller 11a that contacts the intermediate transfer belt 3. Thus, the detector 28 stably detects the amount of the electric current supplied to the primary transfer roller 11a for the black toner image, that is, one of the four primary transfer rollers 11a, 11b, 11c, and 11d.

The image forming apparatus 100 employs the indirect transfer method using the primary transfer rollers 11a, 11b, 11c, and 11d made of metal, eliminating a control for changing a target transfer bias whenever an environment changes over time. Hence, the image forming apparatus 100 eliminates driving of the intermediate transfer belt 3 and the photoconductors 1a, 1b, 1c, and 1d whenever the environment changes, extending a life of the intermediate transfer belt 3 and the photoconductors 1a, 1b, 1c, and 1d.

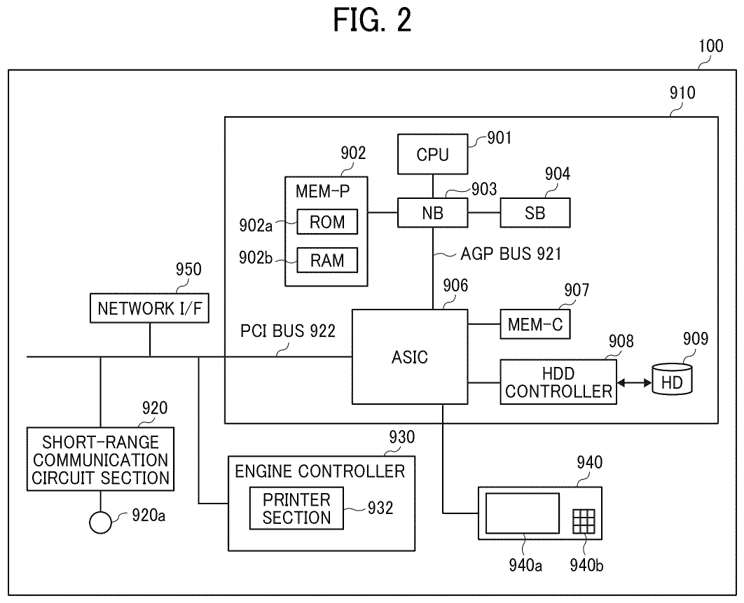

FIG. 2 is a block diagram of the image forming apparatus 100, illustrating a hardware configuration thereof.

As illustrated in FIG. 2, the image forming apparatus 100 further includes a controller 910, a short-range communication circuit section 920, the engine controller 930, a control panel 940, and a network interface (I/F) 950.

The controller 910 controls an entirety of the image forming apparatus 100. For example, the controller 910 controls drawing, communication, inputs from the control panel 940, and the like.

The controller 910 includes a central processing unit (CPU) 901 serving as a main component of a computer, a system memory (MEM-P) 902, a northbridge (NB) 903, a southbridge (SB) 904, an application specific integrated circuit (ASIC) 906, a local memory (MEM-C) 907 serving as a memory, a hard disc drive (HDD) controller 908, a hard disc (HD) 909 serving as a memory, an accelerated graphics port (AGP) bus 921, and a peripheral component interconnect (PCI) bus 922. The NB 903 is connected to the ASIC 906 via the AGP bus 921.

The CPU 901 serves as a controller that controls the entirety of the image forming apparatus 100. The NB 903 is a bridge that connects the CPU 901, the MEM-P 902, the SB 904, and the AGP bus 921. The NB 903 includes a memory controller, a peripheral component interconnect (PCI) master, and an accelerated graphics port (AGP) target. The memory controller controls reading, writing, and the like with respect to the MEM-P 902.

The MEM-P 902 includes a read only memory (ROM) 902a and a random access memory (RAM) 902b. The ROM 902a is a memory that stores programs and data that establish functions of the controller 910. The RAM 902b is a memory or the like that loads the programs and the data and is used for drawing in printing. The programs stored in the RAM 902b may be recorded in computer-readable recording media such as a compact disc read only memory (CD-ROM), a compact disc-recordable (CD-R), and a digital versatile disc (DVD) in a file format that is installable or executable.

The SB 904 is a bridge that connects the NB 903, a peripheral component interconnect (PCI) device, and a peripheral device. The ASIC 906 is an integrated circuit (IC) that includes hardware components for image processing and is used for image processing. The ASIC 906 is a bridge that connects the AGP bus 921, the PCI bus 922, the HDD controller 908, and the MEM-C 907. The ASIC 906 includes an arbiter (ARB), a memory controller, a plurality of direct memory access controllers (DMAC), and a peripheral component interconnect (PCI) unit. The ARB is a core of a peripheral component interconnect (PCI) target, an accelerated graphics port (AGP) master, and the ASIC 906. The memory controller controls the MEM-C 907. The DMACs perform rotation and the like of image data with hardware logic or the like. The engine controller 930 includes a printer section 932. The PCI unit performs data transmission with the printer section 932 via the PCI bus 922. Alternatively, the ASIC 906 may be connected to a universal serial bus (USB) interface or an institute of electrical and electronics engineers (IEEE) 1394 interface.

The MEM-C 907 is a local memory used as an image buffer for copying and a sign buffer. The HD 909 is a storage that stores image data, font data used for printing, and forms. The HD 909 controls reading or writing of data with respect to the HD 909 according to a control by the CPU 901. The AGP bus 921 is a bus interface for a graphics accelerator card proposed to accelerate graphics processing. The AGP bus 921 accesses the MEM-P 902 directly at an increased throughput, accelerating the graphics accelerator card.

The short-range communication circuit section 920 includes a short-range communication circuit 920a. The short-range communication circuit section 920 is a communication circuit using near field communication (NFC), Bluetooth®, or the like.

The engine controller 930 controls the printer section 932 to control image forming operation. The printer section 932 includes a driver that drives and rotates the photoconductors 1a, 1b, 1c, and 1d, a driver that drives and rotates the intermediate transfer belt 3, and devises such as the developing devices 10 that form a toner image on a recording medium P. The printer section 932 further includes an image processor that performs error diffusion, gamma correction, and the like.

The control panel 940 serving as a control-input device includes a display panel 940a and a keyboard 940b (e.g., a control portion). The display panel 940a displays current settings, a selection screen, and the like. The display panel 940a includes a touch panel that receives instructions from an operator (e.g., a user). The keyboard 940b includes number keys and a start key. The operator inputs setting values for image forming conditions such as image density with the number keys. The operator presses the start key to start copying.

The control panel 940 further includes application switch keys. As the operator selectively presses one of the application switch keys, the image forming apparatus 100 switches between a document server function, a printer function, a facsimile function, and the like successively. As the operator selects the document server function, the image forming apparatus 100 enters a document server mode. As the operator selects the printer function, the image forming apparatus 100 enters a printer mode. As the operator selects the facsimile function, the image forming apparatus 100 enters a facsimile mode.

The network I/F 950 is an interface for data communications using a communication network. The short-range communication circuit section 920 and the network I/F 950 are electrically connected to the ASIC 906 through the PCI bus 922.

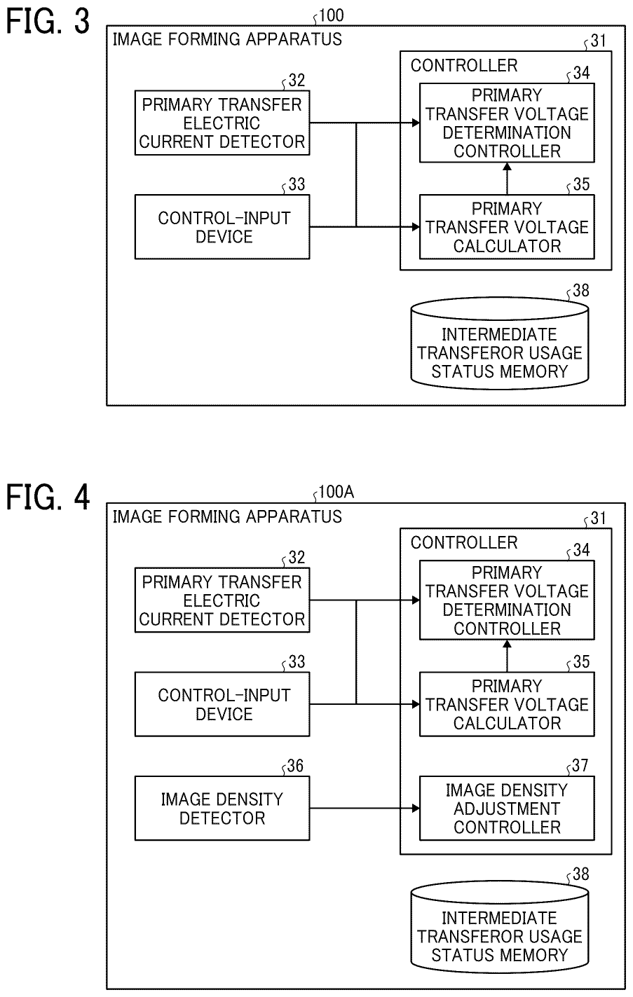

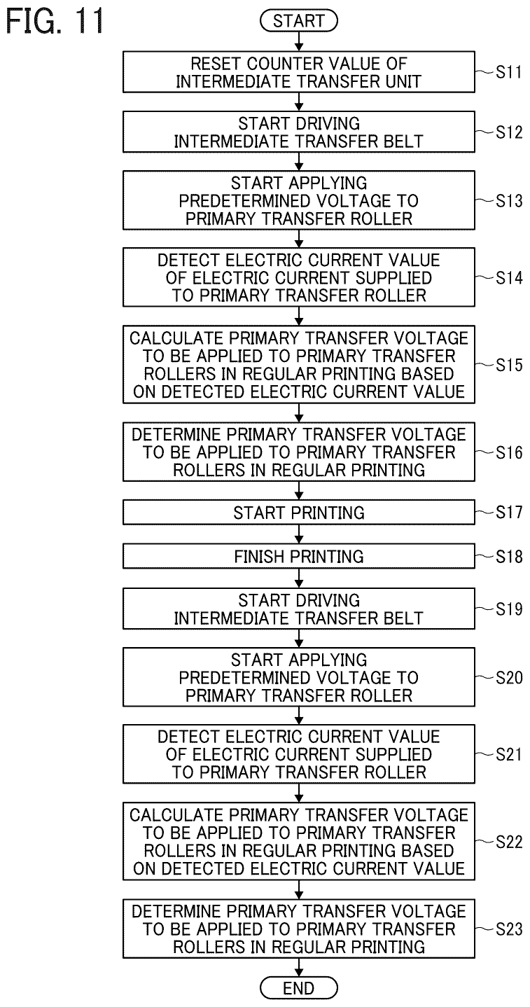

FIG. 3 is a block diagram of the image forming apparatus 100, illustrating a functional configuration thereof that performs processes described below with reference to FIG. 11.

As illustrated in FIG. 3. the image forming apparatus 100 includes a primary transfer electric current detector 32, a control-input device 33, a controller 31, and an intermediate transferor usage status memory 38. The controller 31 includes a primary transfer voltage determination controller 34 and a primary transfer voltage calculator 35.

The controller 31 includes the engine controller 930 that controls the printer section 932 to control image forming operation. The primary transfer electric current detector 32 includes the detector 28 that detects an electric current value of an electric current supplied to the primary transferor such as the primary transfer roller 11 that primarily transfers a toner image formed on the image bearer such as the photoconductor 1 onto the intermediate transferor such as the intermediate transfer belt 3 at the primary transfer portion N.

The control-input device 33 includes the control panel 940 that receives an instruction input by the user.

The primary transfer voltage determination controller 34 determines a primary transfer voltage to be applied to the primary transferor based on the electric current value of the electric current supplied to the primary transferor such as the primary transfer roller 11, that is detected by the primary transfer electric current detector 32 such as the detector 28.

The primary transfer voltage calculator 35 calculates the primary transfer voltage according to a transformation formula that transforms the electric current value detected by the primary transfer electric current detector such as the detector 28 to the primary transfer voltage.

The intermediate transferor usage status memory 38 includes the memory such as the HD 909 that stores a usage status of the intermediate transferor such as a number of pages printed from start of usage of the intermediate transferor such as the intermediate transfer belt 3.

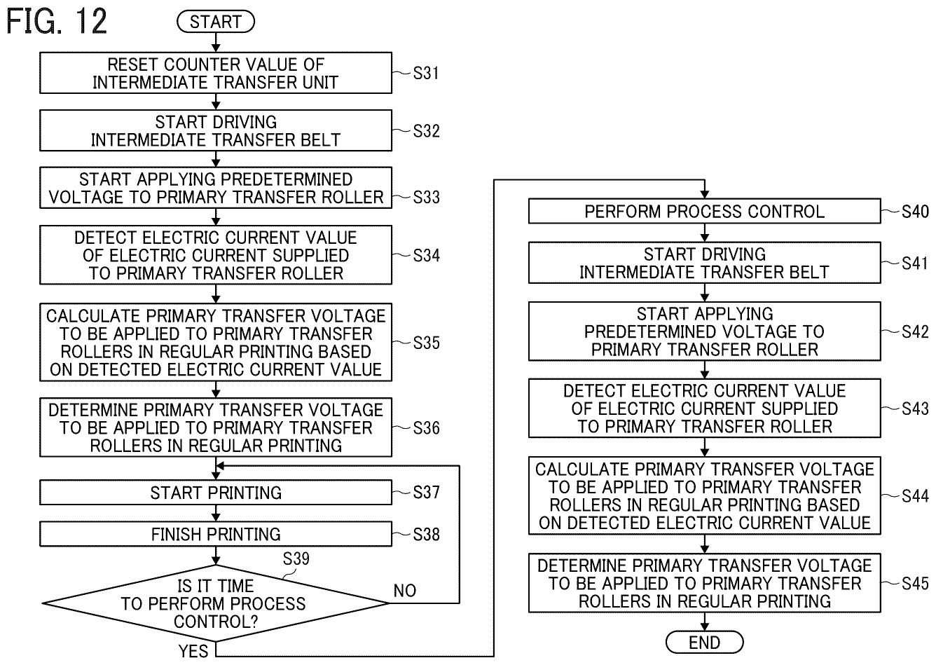

FIG. 4 is a block diagram of an image forming apparatus 100A, illustrating a functional configuration thereof that performs processes described below with reference to FIG. 12.

As illustrated in FIG. 4, the image forming apparatus 100A includes the primary transfer electric current detector 32, the control-input device 33, the controller 31, the intermediate transferor usage status memory 38, and an image density detector 36. The controller 31 includes the primary transfer voltage determination controller 34, the primary transfer voltage calculator 35, and an image density adjustment controller 37.

The controller 31 includes the engine controller 930 that controls the printer section 932 to control image forming operation. The primary transfer electric current detector 32 includes the detector 28 that detects an electric current value of an electric current supplied to the primary transferor such as the primary transfer roller 11 that primarily transfers a toner image formed on the image bearer such as the photoconductor 1 onto the intermediate transferor such as the intermediate transfer belt 3 at the primary transfer portion N.

The control-input device 33 includes the control panel 940 that receives an instruction input by the user. The image density detector 36 includes the optical sensor 22 that detects an image density of the toner image borne on the image bearer or the intermediate transferor.

The primary transfer voltage determination controller 34 determines a primary transfer voltage to be applied to the primary transferor based on the electric current value of the electric current supplied to the primary transferor such as the primary transfer roller 11, that is detected by the primary transfer electric current detector 32 such as the detector 28.

The primary transfer voltage calculator 35 calculates the primary transfer voltage according to a transformation formula that transforms the electric current value detected by the primary transfer electric current detector such as the detector 28 to the primary transfer voltage.

The intermediate transferor usage status memory 38 includes the memory such as the HD 909 that stores a usage status of the intermediate transferor such as the number of pages printed from start of usage of the intermediate transferor such as the intermediate transfer belt 3.

The image density detector 36 such as the optical sensor 22 detects an image density of the toner image borne on the image bearer such as the photoconductor 1 or the intermediate transferor such as the intermediate transfer belt 3. Based on a detection result, that is, the image density, sent from the image density detector 36, the image density adjustment controller 37 performs a control such as a process control that adjusts an image forming condition of the image forming device 6 including the charger 8, the exposure device 9, and the developing device 10. The image forming device 6 forms the toner image on the image bearer.

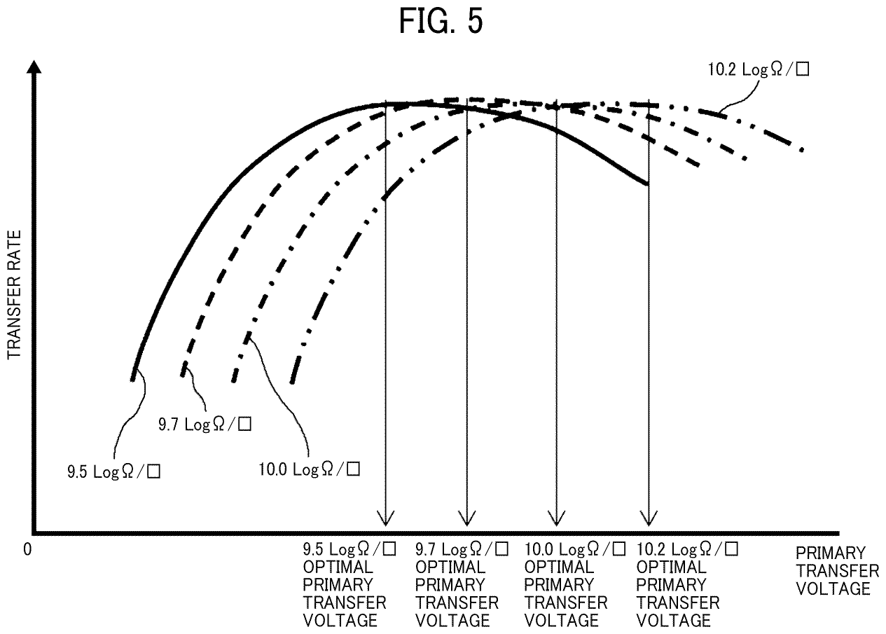

FIG. 5 is a graph illustrating a relation between a primary transfer voltage and a transfer rate of toner of a toner image transferred from the photoconductor 1 onto the intermediate transfer belt 3.

At each of surface resistivities of the intermediate transfer belt 3 of 9.5 Log Ω/□, 9.7 Log Ω/□, 10.0 Log Ω/□, and 10.2 Log Ω/□, the relation between the primary transfer voltage and the transfer rate varies. Hence, as illustrated with four arrows in FIG. 5, an optimal primary transfer voltage at which the transfer rate is maximum also varies. Accordingly, in a case that the primary transfer power supply 27BK for the black toner image is under a constant voltage control, the surface resistivity of the intermediate transfer belt 3 varies the optimal primary transfer voltage. To address the circumstance, the primary transfer voltage is determined based on the surface resistivity of the intermediate transfer belt 3.

The surface resistivity of the intermediate transfer belt 3 is estimated based on an average electric current value detected by the detector 28 when a predetermined bias of 2,000 V is applied for approximately a belt length of the intermediate transfer belt 3 in the rotation direction A thereof. Accordingly, based on the average electric current value detected by the detector 28, the engine controller 930 determines the optimal primary transfer voltage to be applied to the primary transfer roller 11a, at which the transfer rate is maximum.

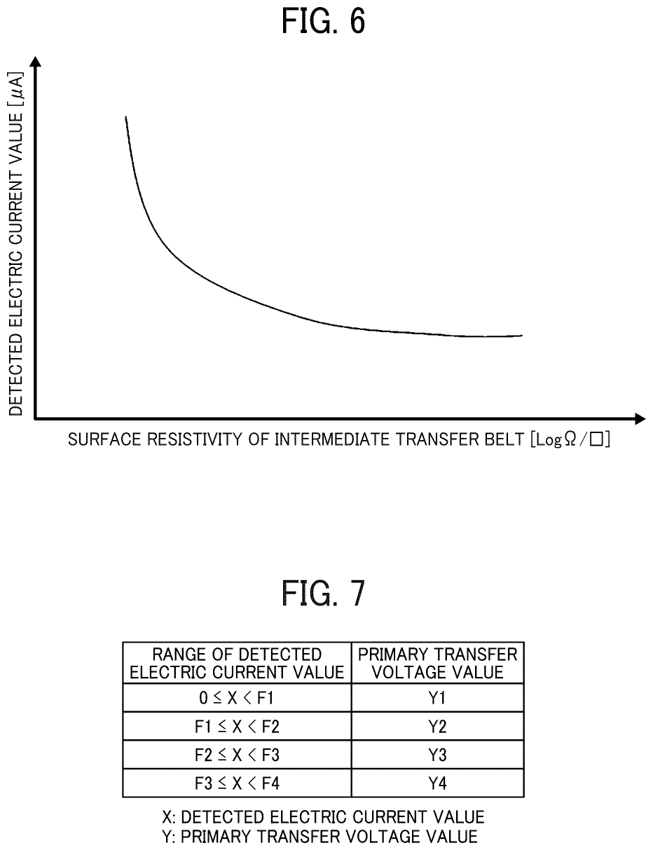

FIG. 6 is a graph illustrating a relation between the surface resistivity of the intermediate transfer belt 3 and the electric current value detected by the detector 28.

FIG. 6 illustrates a detected electric current value that is the average electric current value detected by the detector 28 when the predetermined bias of 2,000 V is applied for approximately the belt length of the intermediate transfer belt 3 in the rotation direction A thereof.

As illustrated in FIG. 6, as the detected electric current value increases, the surface resistivity of the intermediate transfer belt 3 decreases.

According to the embodiment, the detector 28, together with the primary transfer power supply 27BK for the black toner image, detects the electric current supplied to the primary transfer roller 11a for the black toner image. The engine controller 930 determines a primary transfer voltage to be applied to the primary transfer rollers 11a, 11b, 11c, and 11d for toner images in four colors, that is, the black, magenta, cyan, and yellow toner images, respectively.

The engine controller 930 determines the primary transfer voltage based on the average electric current value detected by the detector 28 in two methods, that is, a first method and a second method described below. In the first method, based on a detected electric current value X also referred to as an electric current value X detected by the detector 28 and a bias table illustrated in FIG. 7, the engine controller 930 determines a fixed primary transfer voltage value Y that is constant according to the detected electric current value X. The HD 909 serving as the memory stores the bias table depicted in FIG. 7.

The bias table depicted in FIG. 7 illustrates four ranges of the detected electric current value X and four primary transfer voltage values Y1, Y2, Y3, and Y4 that correspond to the four ranges, respectively. In the first method, the engine controller 930 simply selects one of the four fixed primary transfer voltage values Y1, Y2, Y3, and Y4, that corresponds to the detected electric current value X, simplifying a control for determining the primary transfer voltage value Y.

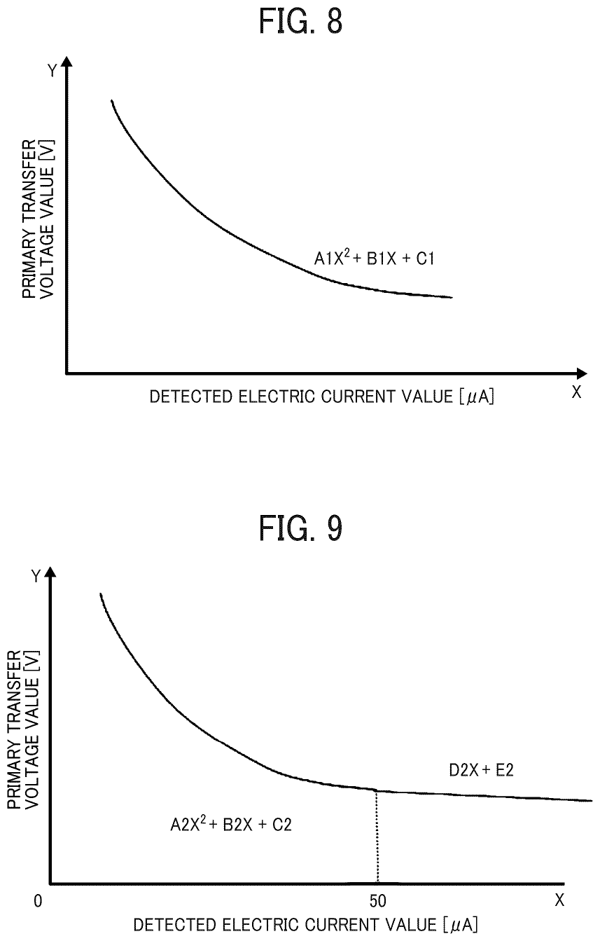

In the second method, the engine controller 930 calculates the primary transfer voltage value Y based on the detected electric current value X with a transformation formula. FIG. 8 is a graph illustrating the transformation formula.

As illustrated in FIG. 8, the transformation formula is a quadratic function. It is confirmed through validation that the transformation formula as the quadratic function is suitable for the engine controller 930 to determine the optimal primary transfer voltage at which the transfer rate is maximum.

FIG. 8 illustrates a transformation formula (1) as the quadratic function.

Y=A1*X²+B1*X+C1(A1≠0) (1)

The transformation formula is the quadratic function that defines the detected electric current value X as an independent variable.

For example, A1 equals to 0.5. B1 equals to −77. C1 equals to 3,700.

In a case that X equals to 50 [μA], Y equals to 1,100 [V].

However, the optimal transformation formula may change according to a condition of the primary transfer portion N and a periphery thereof, for example, a distance between the photoconductor 1 and the primary transfer roller 11 and a type of toner used.

In the second method, the engine controller 930 precisely determines the optimal primary transfer voltage value Y that addresses variation in surface resistivity of the intermediate transfer belt 3.

As illustrated in FIG. 9, the transformation formula may change according to the range of the detected electric current value X.

FIG. 9 illustrates an example that uses two transformation formulas (2) and (3) below.

Y=A2*X²+B2*X+C2(A2≠0) (2)

Y=D2*X+E2(D2≠0) (3)

In a case that X is smaller than 50 [μA], the engine controller 930 uses the transformation formula (2). In a case that X is not smaller than 50 [μA], the engine controller 930 uses the transformation formula (3).

The engine controller 930 determines the transformation formula used to calculate the primary transfer voltage value Y according to the plurality of transformation formulas that corresponds to the detected electric current value X and in which the detected electric current value X is a variable.

For example, A2 equals to 0.5. B2 equals to −77. C2 equals to 3,700. D2 equals to −22. E2 equals to 2,200.

Hence, in a case that X equals to 60 [μA], Y equals to 880 [V].

As described above, also with the transformation formula that changes according to the detected electric current value, the engine controller 930 precisely determines the optimal primary transfer voltage that addresses variation in surface resistivity of the intermediate transfer belt 3.

As described above, the engine controller 930 calculates the standard primary transfer voltage value Y by using the transformation formula. Alternatively, according to a usage environment in which the image forming apparatus 100 is used and a linear velocity of the intermediate transfer belt 3 that varies depending on a type of the recording medium P and a mode of printing, the engine controller 930 may determine the primary transfer voltage value Y by multiplying the detected electric current value X by a correction factor for the usage environment and the linear velocity of the intermediate transfer belt 3.

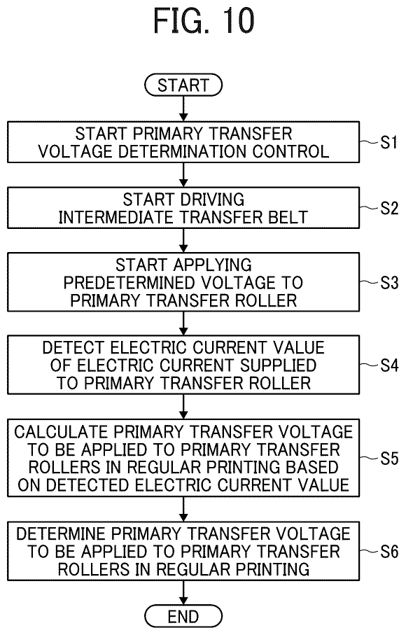

FIG. 10 is a flowchart of a primary transfer voltage determination control.

In step S1, the engine controller 930 starts the primary transfer voltage determination control. In step S2, the driver starts driving the driving roller 4 that drives the intermediate transfer belt 3. In step S3, the engine controller 930 controls the primary transfer power supply 27BK for the black toner image to start applying a predetermined voltage of 2,000 V to the primary transfer roller 11. According to the embodiment, the primary transfer roller 11a is applied with the predetermined voltage. Alternatively, one or more of other primary transfer rollers, that is, the primary transfer rollers 11b, 11c, and 11d, may be applied with the predetermined voltage. In step S4, the detector 28 detects an electric current value of an electric current supplied to the primary transfer roller 11.

As the detector 28 detects the electric current while the intermediate transfer belt 3 rotates for approximately a single rotation, that is, for approximately the belt length of the intermediate transfer belt 3 in the rotation direction A thereof, the engine controller 930 calculates the detected electric current value X (e.g., an average electric current value). Based on the detected electric current value X, the engine controller 930 calculates a primary transfer voltage to be applied to the primary transfer rollers 11 in regular printing with any one of the methods depicted in FIGS. 7 to 9 in step S5. The primary transfer voltage defines a primary transfer voltage value to be applied to the primary transfer rollers 11a, 11b, 11c, and 11d used to form black, magenta, cyan, and yellow toner images, respectively. Thus, the engine controller 930 determines the primary transfer voltage to be applied to the primary transfer rollers 11a, 11b, 11c, and 11d in regular printing in step S6.

The engine controller 930 performs the primary transfer voltage determination control depicted in FIG. 10 when the intermediate transfer belt 3 is replaced with a new one, for example. As the intermediate transfer belt 3 is replaced with the new one, the new intermediate transfer belt 3 has a surface resistivity that is different from a surface resistivity of the used intermediate transfer belt 3, changing the optimal primary transfer voltage at which the transfer rate is maximum.

According to the embodiment, the engine controller 930 performs the primary transfer voltage determination control whenever a predetermined number of pages of recording media P is printed. As the intermediate transfer belt 3 is used over time, the surface resistivity of the intermediate transfer belt 3 changes, thus changing the optimal primary transfer voltage at which the transfer rate is maximum. According to the embodiment, the engine controller 930 performs the primary transfer voltage determination control whenever 10,000 pages are printed. For example, as described below, the memory such as the HD 909 stores a counter value, that is, the number of pages printed, counted from start of usage of the intermediate transfer unit 2 (e.g., the intermediate transfer belt 3). The engine controller 930 performs the primary transfer voltage determination control based on the counter value.

In a case that the surface resistivity of the intermediate transfer belt 3 barely changes over time, the engine controller 930 may perform the primary transfer voltage determination control at a limited time when the intermediate transfer belt 3 is replaced. Accordingly, the intermediate transfer belt 3 and the photoconductors 1 do not move unnecessarily and therefore move in a minimum amount, also extending a life of other parts.

According to the embodiment, as the operator (e.g., a service engineer or the user) replaces the intermediate transfer unit 2 into which the intermediate transfer belt 3, the primary transfer rollers 11a, 11b, 11c, and 11d, the cleaning blade 21, and the like are combined, the intermediate transfer belt 3 is replaced. Alternatively, the operator may replace the intermediate transfer belt 3 independently.

The engine controller 930 determines whether or not the intermediate transfer unit 2 (e.g., the intermediate transfer belt 3) is replaced based on intermediate transferor replacement data that indicates that the intermediate transfer unit 2 is replaced and is input by the user by using the control panel 940 when the user replaces the intermediate transfer unit 2. For example, according to the embodiment, in order to recognize a usage status of the intermediate transfer unit 2 (e.g., the intermediate transfer belt 3), the number of pages printed is counted from start of usage of the intermediate transfer unit 2. The HD 909 serving as the memory stores the counted number of pages printed as a counter value. After the user replaces the intermediate transfer unit 2 (e.g., the intermediate transfer belt 3), the user presses a counter reset button displayed on the display panel 940a of the control panel 940 to create counter reset data, resetting the counter value representing the number of pages printed by the intermediate transfer unit 2. The counter reset data, as the intermediate transferor replacement data that indicates that the intermediate transfer belt 3 is replaced and is input by using the control panel 940, triggers the primary transfer voltage determination control when the intermediate transfer unit 2 (e.g., the intermediate transfer belt 3) is replaced. As described above, when the user inputs the counter reset data by using the control panel 940, the engine controller 930 performs the primary transfer voltage determination control. Thus, the user does not wait for start of an initial print job after replacement of the intermediate transfer belt 3.

However, the user may make a mistake in replacement procedures and may press the counter reset button on the control panel 940 erroneously before the user replaces the intermediate transfer unit 2 (e.g., the intermediate transfer belt 3). In this case, in a state in which the used intermediate transfer belt 3 before replacement is installed in the image forming apparatus 100, the engine controller 930 may perform the primary transfer voltage determination control. Thereafter, the user may replace the intermediate transfer unit 2 (e.g., the intermediate transfer belt 3). Accordingly, the image forming apparatus 100 may perform image formation at an inappropriate primary transfer voltage at which the transfer rate degrades until the engine controller 930 performs a subsequent primary transfer voltage determination control when 10,000 pages of recording media P are printed. Consequently, the recording media P may bear toner images having an image density that is smaller than a proper image density. Toner in an increased amount may not be primarily transferred from the photoconductor 1 onto the intermediate transfer belt 3 and may remain on the photoconductor 1 as residual toner. As a result, toner may be consumed and wasted until the engine controller 930 performs the subsequent primary transfer voltage determination control.

For example, the image forming apparatus 100 may include a detecting mechanism including a detector that detects an integrated circuit (IC) tag installed in the intermediate transfer unit 2 and an IC tag installed in the image forming apparatus 100. The detecting mechanism detects replacement of the intermediate transfer unit 2 (e.g., the intermediate transfer belt 3) so that the engine controller 930 performs the primary transfer voltage determination control, preventing the inappropriate primary transfer voltage. However, the image forming apparatus 100 incorporating the detecting mechanism may suffer from increase in a number of parts, resulting in increased costs.

To address the circumstance, according to an embodiment, after the image forming apparatus 100 finishes the initial print job (e.g., image formation) after replacement of the intermediate transfer unit 2 (e.g., the intermediate transfer belt 3), the engine controller 930 performs the primary transfer voltage determination control again.

FIG. 11 is a flowchart of the primary transfer voltage determination control performed by the engine controller 930 according to the embodiment when the intermediate transfer unit 2 is replaced.

In step S11, the user inputs the counter reset data of the intermediate transfer unit 2 as the intermediate transferor replacement data by using the control panel 940, thus resetting a counter value of the intermediate transfer unit 2. The engine controller 930 performs a primary transfer voltage determination control similar to the primary transfer voltage determination control depicted in FIG. 10. For example, in step S12, the driver starts driving the intermediate transfer belt 3. In step S13, the primary transfer power supply 27BK starts applying the predetermined voltage of 2,000 V to the primary transfer roller 11. In step S14, the detector 28 detects an electric current value of an electric current supplied to the primary transfer roller 11. In step S15, based on the detected electric current value X (e.g., an average electric current value) detected by the detector 28, the engine controller 930 calculates a primary transfer voltage to be applied to the primary transfer rollers 11 in regular printing with any one of the methods depicted in FIGS. 7 to 9. In step S16, the engine controller 930 determines the primary transfer voltage, that is, the calculated primary transfer voltage, to be applied to the primary transfer rollers 11a, 11b, 11c, and 11d used to form black, magenta, cyan, and yellow toner images, respectively, in regular printing. The primary transfer voltage determination control includes steps S12 to S16.

In step S17, the image forming apparatus 100 starts an initial print job, that is, starts printing, after replacement of the intermediate transfer unit 2 (e.g., the intermediate transfer belt 3). In step S18, the image forming apparatus 100 finishes the initial print job, that is, finishes printing. The engine controller 930 performs the primary transfer voltage determination control again in steps S19 to S23. The primary transfer voltage determination control includes steps S19 to S23. The engine controller 930 checks a counter value representing the number of pages printed by the intermediate transfer unit 2 stored in the memory such as the HD 909. The counter value represents a usage status of the intermediate transfer belt 3. Thus, the engine controller 930 determines whether or not the image forming apparatus 100 performs the initial print job. For example, when the image forming apparatus 100 starts the initial print job, the engine controller 930 checks the counter value representing the number of pages printed by the intermediate transfer unit 2. If the counter value is zero, the engine controller 930 identifies the initial print job after replacement of the intermediate transfer belt 3.

As described above, after the image forming apparatus 100 finishes the initial print job (e.g., image formation) after replacement of the intermediate transfer unit 2 (e.g., the intermediate transfer belt 3), the engine controller 930 performs the primary transfer voltage determination control again. Accordingly, even if the engine controller 930 performs the primary transfer voltage determination control triggered by pressing of the counter reset button by the user before the intermediate transfer belt 3 is replaced and therefore the engine controller 930 determines an inappropriate primary transfer voltage, the image forming apparatus 100 prints at the inappropriate primary transfer voltage in a limited print job, that is, the initial print job. Accordingly, in a subsequent print job and thereafter, the intermediate transfer unit 2 primarily transfers the toner images at an optimal primary transfer voltage (e.g., a primary transfer voltage at which the transfer rate is maximum) according to a surface resistivity of the new intermediate transfer belt 3, preventing a decreased image density and an increased amount of residual toner remaining on the photoconductors 1. After the print job finishes, the engine controller 930 performs the primary transfer voltage determination control. Thus, the image forming apparatus 100 prevents extension of a first print time taken to produce a first page of a print job from a time when the image forming apparatus 100 receives a print command. The image forming apparatus 100 also prevents the user from waiting for finishing of the print job.

The initial print job after replacement of the intermediate transfer unit 2 (e.g., the intermediate transfer belt 3) defines a print job for printing a test pattern. The display panel 940a of the control panel 940 displays a screen that instructs the user to check whether or not the test pattern has a decreased image density. In a case that the user checks the printed test pattern and determines that the printed test pattern has the decreased image density, the user inputs an instruction that instructs the engine controller 930 to perform the primary transfer voltage determination control again by using the control panel 940. When the engine controller 930 receives the instruction from the user, the engine controller 930 may perform the primary transfer voltage determination control.

As illustrated in FIG. 11, after the initial print job (e.g., image formation) finishes after replacement of the intermediate transfer unit 2 (e.g., the intermediate transfer belt 3), the engine controller 930 performs the primary transfer voltage determination control again. After the image forming apparatus 100 performs an initial process control after replacement of the intermediate transfer unit 2, the engine controller 930 may perform the primary transfer voltage determination control again. According to the embodiment, the image forming apparatus 100 performs a process control per 30 pages printed. The image forming apparatus 100 performs the process control at an interval longer than an interval defined by 30 pages printed depending on a model of the image forming apparatus 100. However, the image forming apparatus 100 performs the process control per a maximum of 200 pages printed. Thus, the image forming apparatus 100 performs the process control at a substantially decreased interval compared to an interval of the primary transfer voltage determination control performed per 10,000 pages printed. Accordingly, after the image forming apparatus 100 performs the initial process control after replacement of the intermediate transfer unit 2, the engine controller 930 performs the primary transfer voltage determination control again, determining an appropriate primary transfer voltage at a time earlier than a time when the engine controller 930 performs the subsequent primary transfer voltage determination control.

FIG. 12 is a flowchart of the primary transfer voltage determination control performed again after an initial process control after the intermediate transfer unit 2 (e.g., the intermediate transfer belt 3) is replaced.

As illustrated in FIG. 12, in steps S31 to S36, as the user presses the counter reset button, the engine controller 930 performs the primary transfer voltage determination control to determine the primary transfer voltage to be applied to the primary transfer rollers 11a, 11b, 11c, and 11d. The primary transfer voltage determination control includes steps S32 to S36.

In step S37, the image forming apparatus 100 starts a print job for printing on a predetermined number of pages, that is, starts printing. In step S38, the image forming apparatus 100 finishes the print job, that is, finishes printing. In step S39, the engine controller 930 determines whether or not it is a time to perform a process control. If the engine controller 930 determines that it is the time to perform the process control (YES in step S39), the engine controller 930 performs an initial process control after replacement of the intermediate transfer unit 2 (e.g., the intermediate transfer belt 3) in step S40. The engine controller 930 determines whether or not a process control to be performed is the initial process control after replacement of the intermediate transfer unit 2 (e.g., the intermediate transfer belt 3) as described below, for example. If a counter value representing the number of pages printed by the intermediate transfer unit 2, that is stored in the memory such as the HD 909, is smaller than a number of pages printed in a process control execution interval, the engine controller 930 determines that it is the time to perform the initial process control. The engine controller 930 sets a flag when the user resets the counter value representing the number of pages printed by the intermediate transfer unit 2. In a case that the flag is set when the process control is performed, the engine controller 930 may determine whether or not the process control to be performed is the initial process control after replacement of the intermediate transfer unit 2 (e.g., the intermediate transfer belt 3).

After the engine controller 930 performs the initial process control after replacement of the intermediate transfer unit 2 (e.g., the intermediate transfer belt 3), the engine controller 930 performs the primary transfer voltage determination control again, determining a primary transfer voltage to be applied to the primary transfer rollers 11a, 11b, 11c, and 11d in steps S41 to S45. The primary transfer voltage determination control includes steps S41 to S45.

As described above, the engine controller 930 performs the primary transfer voltage determination control after the process control. Alternatively, the engine controller 930 may perform the process control after the primary transfer voltage determination control. For example, when the engine controller 930 determines that it is the time to perform the process control, the engine controller 930 determines whether or not the process control to be performed is an initial process control after replacement of the intermediate transfer unit 2 (e.g., the intermediate transfer belt 3). If the engine controller 930 determines that the process control to be performed is the initial process control after replacement of the intermediate transfer unit 2 (e.g., the intermediate transfer belt 3), the engine controller 930 performs the process control after the primary transfer voltage determination control. Accordingly, at the appropriate primary transfer voltage, the engine controller 930 performs the process control, adjusting an image density precisely.

In the primary transfer voltage determination control, the charger 8 may uniformly charge the surface of the photoconductor 1 so that the detector 28 detects an electric current value. While the primary transfer roller 11 primarily transfers a toner image formed on the photoconductor 1 onto the intermediate transfer belt 3, a surface potential on the photoconductor 1 may change a primary transfer electric current supplied to the primary transfer roller 11, varying the transfer rate. To address the circumstance, the charger 8 uniformly charges the surface of the photoconductor 1 so that the detector 28 detects the electric current value. The engine controller 930 determines the primary transfer voltage based on the detected electric current value. Hence, the engine controller 930 determines the primary transfer voltage by considering an electric resistance of the intermediate transfer belt 3 and the surface potential on the photoconductor 1 while the primary transfer roller 11 primarily transfers the toner image. Thus, the engine controller 930 determines an optimal primary transfer voltage precisely. In a case of the primary transfer voltage determination control based on the electric current value detected by the detector 28 after the charger 8 uniformly charges the surface of the photoconductor 1, as illustrated in FIG. 12, the engine controller 930 preferably performs the primary transfer voltage determination control after an initial process control after replacement of the intermediate transfer unit 2 (e.g., the intermediate transfer belt 3). Accordingly, in the primary transfer voltage determination control, the charger 8 uniformly charges the surface of the photoconductor 1 at a charging bias optimized by the process control so that the detector 28 detects the electric current value. Thus, the engine controller 930 determines the optimal primary transfer voltage precisely.

In a case of the primary transfer voltage determination control based on the electric current value detected by the detector 28 after the charger 8 uniformly charges the surface of the photoconductor 1, the engine controller 930 preferably performs the primary transfer voltage determination control before and after the initial process control. Accordingly, the engine controller 930 adjusts the image density precisely and determines the optimal primary transfer voltage.

As described above, as data used to recognize the usage status of the intermediate transfer unit 2 (e.g., the intermediate transfer belt 3), the counter value representing the number of pages printed, that is counted from start of usage of the intermediate transfer unit 2 (e.g., the intermediate transfer belt 3), is used. Alternatively, other data may be employed. For example, a total belt mileage or a total motor runtime may be employed as data used to recognize the usage status of the intermediate transfer unit 2 (e.g., the intermediate transfer belt 3). The total belt mileage defines a total distance for which the intermediate transfer belt 3 travels over time. The total motor runtime defines a total amount of time for which a driving motor that drives the intermediate transfer belt 3 operates. In a case of recognizing the usage status of the intermediate transfer unit 2 (e.g., the intermediate transfer belt 3) based on the total belt mileage of the intermediate transfer belt 3, when the user replaces the intermediate transfer unit 2 (e.g., the intermediate transfer belt 3), the user resets the total belt mileage of the intermediate transfer belt 3 by using the control panel 940. The engine controller 930 obtains reset data, that indicates that the total belt mileage is reset and is input with the control panel 940, as replacement data of the intermediate transfer unit 2, performing the primary transfer voltage determination control.

In a case of recognizing the usage status of the intermediate transfer unit 2 (e.g., the intermediate transfer belt 3) based on the total motor runtime of the driving motor that drives the intermediate transfer belt 3, when the user replaces the intermediate transfer unit 2 (e.g., the intermediate transfer belt 3), the user resets the total motor runtime of the driving motor by using the control panel 940. The engine controller 930 obtains reset data, that indicates that the total motor runtime is reset and is input with the control panel 940, as replacement data of the intermediate transfer unit 2, performing the primary transfer voltage determination control.

As described above, the image forming apparatus 100 according to the embodiment includes the single detector 28 that detects the electric current value of the electric current supplied to the primary transfer roller 11a for the black toner image when the primary transfer power supply 27BK for the black toner image applies a predetermined voltage to the primary transfer roller 11a for the black toner image. The engine controller 930 determines the primary transfer voltage value Y to be applied to the primary transfer rollers 11a, 11b, 11c, and 11d for the black, magenta, cyan, and yellow toner images, respectively, based on the detected electric current value. Accordingly, the image forming apparatus 100 reduces costs.

The above describes the embodiments of the present disclosure. However, the technology of the present disclosure is not limited to the specific embodiments and allows various deformation and modification within the scope of the present disclosure unless the above descriptions limit deformation and modification.

The embodiments described above are examples and achieve advantages peculiar to aspects below, respectively.

A description is provided of a first aspect of the technology of the present disclosure.

An image forming apparatus (e.g., the image forming apparatus 100) includes an image bearer (e.g., the photoconductor 1), an intermediate transferor (e.g., the intermediate transfer belt 3), a primary transferor (e.g., the primary transfer roller 11), a primary transfer electric current detector (e.g., the detector 28), a controller (e.g., the engine controller 930), and a control-input device (e.g., the control panel 940).

The primary transferor is applied with a primary transfer voltage. The image bearer bears a toner image. The primary transferor primarily transfers the toner image formed on the image bearer onto the intermediate transferor at a primary transfer portion (e.g., the primary transfer portion N) formed between the image bearer and the intermediate transferor. The primary transfer electric current detector detects an electric current value of an electric current supplied to the primary transferor. The controller performs a primary transfer voltage determination control that determines a primary transfer voltage to be applied to the primary transferor based on the detected electric current value. The control-input device receives an instruction input by a user. The controller performs the primary transfer voltage determination control at a time when the control-input device receives intermediate transferor replacement data that indicates that the intermediate transferor is replaced and is input with the control-input device and a time after an initial image formation after the intermediate transferor is replaced.

A description is provided of a construction of a comparative image forming apparatus.

The comparative image forming apparatus includes an intermediate transfer belt, a controller, and a control panel. The controller performs a primary transfer voltage determination control at a time when a total number of pages printed reaches 1,000 pages after the controller performs a primary transfer voltage determination control previously, at a time when the intermediate transfer belt serving as an intermediate transferor is replaced, and at a time when the comparative image forming apparatus is used initially. As a user inputs data indicating that the intermediate transfer belt is replaced as intermediate transferor replacement data by using the control panel serving as a control-input device, the controller recognizes that the intermediate transfer belt is replaced. When the comparative image forming apparatus receives an initial print job after replacement of the intermediate transfer belt, the controller performs the primary transfer voltage determination control before the comparative image forming apparatus starts the initial print job.

As described above, the controller performs the primary transfer voltage determination control in an initial image formation (e.g., an initial print job) after the user inputs the intermediate transferor replacement data. When the initial print job is performed after the user inputs the intermediate transferor replacement data, the user usually finishes replacing the intermediate transfer belt serving as the intermediate transferor. Hence, unlike a case that the controller performs the primary transfer voltage determination control at a time when the user inputs the intermediate transferor replacement data, the comparative image forming apparatus attains an advantage described below. For example, in a case that the user performs an abnormal step of inputting the intermediate transferor replacement data before replacement of the intermediate transferor (e.g., the intermediate transfer belt), that is different from a normal step of inputting the intermediate transferor replacement data after replacement of the intermediate transferor, the controller may perform the primary transfer voltage determination control with the used intermediate transferor before replacement and may apply an inappropriate primary transfer voltage to a new intermediate transferor replacing the used intermediate transferor in image formation using the new intermediate transferor. The comparative image forming apparatus avoids such defect. In a case that the controller performs the primary transfer voltage determination control at an extended interval, the controller may continue using the inappropriate primary transfer voltage until the controller performs the primary transfer voltage determination control subsequently. The comparative image forming apparatus avoids such defect advantageously.

However, the comparative image forming apparatus starts the initial print job after replacement of the intermediate transferor after the controller performs the primary transfer voltage determination control. Hence, the primary transfer voltage determination control may take time from reception of the initial print job until the initial print job starts, delaying a first print time.

Conversely, in the image forming apparatus according to the embodiment, the controller performs the primary transfer voltage determination control as the image forming apparatus receives an initial print job after replacement of the intermediate transferor. Hence, even in a case that the user performs the abnormal step of inputting the intermediate transferor replacement data before replacement of the intermediate transferor, that is different from the normal step of inputting the intermediate transferor replacement data after replacement of the intermediate transferor, like in the comparative image forming apparatus, the image forming apparatus performs image formation at an optimal primary transfer voltage after an initial print job (e.g., an initial image formation) after replacement of the intermediate transferor. Additionally, the controller performs the primary transfer voltage determination control after the initial print job, preventing delay in the first print time in the initial print job also. In the image forming apparatus according to the embodiment, the controller performs the primary transfer voltage determination control also at a time when the user inputs the intermediate transferor replacement data. Hence, in a case that the user performs the normal step of inputting the intermediate transferor replacement data after replacement of the intermediate transferor, the image forming apparatus also performs the initial print job after replacement of the intermediate transferor at the optimal primary transfer voltage.

Hence, in a case that the user performs the abnormal step of inputting the intermediate transferor replacement data before replacement of the intermediate transferor, the image forming apparatus performs the initial print job at an inappropriate primary transfer voltage. However, as described above, the image forming apparatus performs image formation at an appropriate primary transfer voltage in subsequent print jobs following the initial print job. Thus, the image forming apparatus avoids an error situation in which the image forming apparatus continues using the inappropriate primary transfer voltage until the controller performs the primary transfer voltage determination control subsequently.

A description is provided of a second aspect of the technology of the present disclosure.

An image forming apparatus (e.g., the image forming apparatus 100) includes an image bearer (e.g., the photoconductor 1), an intermediate transferor (e.g., the intermediate transfer belt 3), a primary transferor (e.g., the primary transfer roller 11), a primary transfer electric current detector (e.g., the detector 28), a controller (e.g., the engine controller 930), a control-input device (e.g., the control panel 940), and an image density detector (e.g., the optical sensor 22).

The primary transferor is applied with a primary transfer voltage. The image bearer bears a toner image. The primary transferor primarily transfers the toner image formed on the image bearer onto the intermediate transferor at a primary transfer portion (e.g., the primary transfer portion N) formed between the image bearer and the intermediate transferor. The primary transfer electric current detector detects an electric current value of an electric current supplied to the primary transferor. The controller performs a primary transfer voltage determination control that determines a primary transfer voltage to be applied to the primary transferor based on the detected electric current value. The control-input device receives an instruction input by a user. The image density detector detects an image density of the toner image borne on the image bearer or the intermediate transferor. Based on a detection result, that is, the image density, sent from the image density detector, the controller performs an image density adjustment control (e.g., a process control) that adjusts an image forming condition of an image forming device (e.g., the image forming device 6) that forms the toner image on the image bearer at an interval smaller than an interval at which the controller performs the primary transfer voltage determination control. The controller performs the primary transfer voltage determination control at a time when the control-input device receives intermediate transferor replacement data that indicates that the intermediate transferor is replaced and a time when the controller performs an initial image density adjustment control after the intermediate transferor is replaced, or a time when the controller finishes the initial image density adjustment control after the intermediate transferor is replaced.

Accordingly, as described above with reference to FIG. 12, when the controller performs the image density adjustment control such as the initial process control after the intermediate transferor is replaced, the controller performs the primary transfer voltage determination control again. Accordingly, even if the user erroneously inputs the intermediate transferor replacement data before replacement of the intermediate transferor and therefore the controller performs the primary transfer voltage determination control before replacement of the intermediate transferor, the image forming apparatus prints at an inappropriate primary transfer voltage until the initial image density adjustment control after replacement of the intermediate transferor. Hence, the controller determines an appropriate primary transfer voltage at a time earlier than a time when the controller performs a subsequent primary transfer voltage determination control and a time when the intermediate transferor is replaced subsequently. Thus, the image forming apparatus suppresses waste toner and printing with a decreased image density.

A description is provided of a third aspect of the technology of the present disclosure.

In the third aspect according to the first aspect or the second aspect, the image forming apparatus includes a plurality of image bearers (e.g., the photoconductors 1a, 1b, 1c, and 1d) and a plurality of primary transferors (e.g., the primary transfer rollers 11a, 11b, 11c, and 11d). The image bearers bear toner images in different colors, respectively. The primary transferors are disposed opposite the image bearers, respectively. The primary transfer electric current detector (e.g., the detector 28) detects an electric current value of an electric current supplied to one of the primary transferors. The controller determines the primary transfer voltage to be applied to the primary transferors based on the electric current value detected by the primary transfer electric current detector.

Accordingly, as described above in the embodiments, compared to a configuration in which primary transfer electric current detectors are disposed opposite the primary transferors, respectively, and the controller determines primary transfer voltages to be applied to the primary transferors based on electric current values detected by the primary transfer electric current detectors, respectively, the image forming apparatus decreases a number of parts, reducing costs.

A description is provided of a fourth aspect of the technology of the present disclosure.

In the fourth aspect according to the third aspect, the primary transferor applied with the electric current having the electric current value detected by the primary transfer electric current detector (e.g., the detector 28) primarily transfers a black toner image onto the intermediate transferor. In other words, the toner image primarily transferred by the primary transferor supplied with the electric current detected by the primary transfer electric current detector is in black.

The image forming apparatus further includes a separator (e.g., a contact and separation mechanism) that separates the primary transferors (e.g., the primary transfer rollers 11b, 11c, and 11d), that primarily transfer magenta, cyan, and yellow toner images onto the intermediate transferor, from the image bearers (e.g., the photoconductors 1b, 1c, and 1d) that bear the magenta, cyan, and yellow toner images, respectively, in a monochrome black mode. Conversely, the primary transferor (e.g., the primary transfer roller 11a) that primarily transfers the black toner image onto the intermediate transferor is disposed at an identical position constantly, stabilizing a positional relation between the image bearer (e.g., the photoconductor 1a) and the intermediate transferor (e.g., the intermediate transfer belt 3) that contacts the image bearer and a positional relation between the primary transferor (e.g., the primary transfer roller 11a) and the intermediate transferor that contacts the primary transferor. Accordingly, the primary transfer electric current detector detects the electric current value of the electric current supplied to the primary transferor that primarily transfers the black toner image onto the intermediate transferor. Thus, the primary transfer electric current detector detects the electric current value stably.

A description is provided of a fifth aspect of the technology of the present disclosure.

In the fifth aspect according to any one of the first to fourth aspects, the image forming apparatus further includes a memory (e.g., the HD 909) that stores a usage status of the intermediate transferor such as a number of pages printed from start of usage of the intermediate transferor (e.g., the intermediate transfer belt 3). The intermediate transferor replacement data includes reset data that resets the usage status and is received by the control-input device.

When the user replaces the intermediate transferor, the user inputs the reset data that resets the usage status of the intermediate transferor by using the control-input device. The controller uses the reset data as the intermediate transferor replacement data, precisely recognizing that the intermediate transferor is replaced.

A description is provided of a sixth aspect of the technology of the present disclosure.

In the sixth aspect according to the fifth aspect, the usage status includes a number of pages printed from start of usage of the intermediate transferor.

Accordingly, the controller recognizes an amount of usage of the intermediate transferor based on the number of pages printed.

A description is provided of a seventh aspect of the technology of the present disclosure.

In the seventh aspect according to any one of the first to sixth aspects, the controller performs the primary transfer voltage determination control based on the number of pages printed.

Accordingly, as described above in the embodiments, the controller determines an optimal primary transfer voltage at which a transfer rate is maximum according to an electric resistance of the intermediate transferor that changes over time. Thus, the image forming apparatus suppresses decrease in image density and waste toner over time.

A description is provided of an eighth aspect of the technology of the present disclosure.

Based on any one of the first to seventh aspects, the controller calculates the primary transfer voltage according to a transformation formula that transforms the electric current value detected by the primary transfer electric current detector (e.g., the detector 28) to the primary transfer voltage.

Accordingly, as described above in the embodiments, compared to a configuration in which detected primary transfer electric currents are classified into a plurality of ranges and a fixed primary transfer voltage is determined for each of the ranges to determine an optimal primary transfer voltage, the controller determines the optimal primary transfer voltage precisely.

According to the embodiments described above, the image forming apparatus 100 is a printer. Alternatively, the image forming apparatus 100 may be a copier, a facsimile machine, a multifunction peripheral (MFP) having at least two of copying, printing, scanning, facsimile, and plotter functions, or the like.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
an image bearer to bear a toner image;
a primary transferor to be applied with a primary transfer voltage;
an intermediate transferor via which the primary transferor is disposed opposite the image bearer to form a primary transfer portion where the primary transferor primarily transfers the toner image formed on the image bearer onto the intermediate transferor;
a primary transfer electric current detector to detect an electric current value of an electric current supplied to the primary transferor;
a control-input device to receive intermediate transferor replacement data that indicates that the intermediate transferor is replaced; and
a controller configured to:
perform a primary transfer voltage determination control that determines the primary transfer voltage based on the detected electric current value; and
perform the primary transfer voltage determination control at a time when the control-input device receives the intermediate transferor replacement data and a time after an initial image formation after the intermediate transferor is replaced.

2. The image forming apparatus according to claim 1, further comprising:
another image bearer to bear another toner image in a color different from a color of the toner image borne on the image bearer; and
another primary transferor disposed opposite said another image bearer,
wherein the controller is configured to determine the primary transfer voltage to be applied to the primary transferor and said another primary transferor based on the electric current value detected by the primary transfer electric current detector.

3. The image forming apparatus according to claim 2,
wherein the toner image primarily transferred by the primary transferor supplied with the electric current detected by the primary transfer electric current detector is in black.

4. The image forming apparatus according to claim 1, further comprising a memory to store a usage status of the intermediate transferor,
wherein the intermediate transferor replacement data includes reset data that resets the usage status, the reset data received by the control-input device.

5. The image forming apparatus according to claim 4,
wherein the usage status includes a number of pages printed from start of usage of the intermediate transferor.

6. The image forming apparatus according to claim 5,
wherein the controller is configured to perform the primary transfer voltage determination control based on the number of pages printed.

7. The image forming apparatus according to claim 1,
wherein the controller is configured to calculate the primary transfer voltage according to a transformation formula that transforms the electric current value detected by the primary transfer electric current detector to the primary transfer voltage.

8. The image forming apparatus according to claim 1,
wherein the image bearer includes a photoconductor,
wherein the intermediate transferor includes an intermediate transfer belt,
wherein the primary transferor includes a primary transfer roller, and
wherein the control-input device includes a control panel.

9. An image forming apparatus comprising:
an image bearer to bear a toner image;
a primary transferor to be applied with a primary transfer voltage;
an intermediate transferor via which the primary transferor is disposed opposite the image bearer to form a primary transfer portion where the primary transferor primarily transfers the toner image formed on the image bearer onto the intermediate transferor;
a primary transfer electric current detector to detect an electric current value of an electric current supplied to the primary transferor;
a control-input device to receive intermediate transferor replacement data that indicates that the intermediate transferor is replaced;
an image density detector to detect an image density of the toner image borne on one of the image bearer and the intermediate transferor; and
a controller configured to:
perform a primary transfer voltage determination control that determines the primary transfer voltage based on the detected electric current value;
perform an image density adjustment control that adjusts an image forming condition under which the toner image is formed on the image bearer based on the image density detected by the image density detector at an interval smaller than an interval at which the controller performs the primary transfer voltage determination control; and
perform the primary transfer voltage determination control at a time when the control-input device receives the intermediate transferor replacement data and a time when the controller finishes the image density adjustment control performed initially after the intermediate transferor is replaced.

10. The image forming apparatus according to claim 9, further comprising:
another image bearer to bear another toner image in a color different from a color of the toner image borne on the image bearer; and
another primary transferor disposed opposite said another image bearer,
wherein the controller is configured to determine the primary transfer voltage to be applied to the primary transferor and said another primary transferor based on the electric current value detected by the primary transfer electric current detector.

11. The image forming apparatus according to claim 10,
wherein the toner image primarily transferred by the primary transferor supplied with the electric current detected by the primary transfer electric current detector is in black.

12. The image forming apparatus according to claim 9, further comprising a memory to store a usage status of the intermediate transferor,
wherein the intermediate transferor replacement data includes reset data that resets the usage status, the reset data received by the control-input device.

13. The image forming apparatus according to claim 12,
wherein the usage status includes a number of pages printed from start of usage of the intermediate transferor.

14. The image forming apparatus according to claim 13,
wherein the controller is configured to perform the primary transfer voltage determination control based on the number of pages printed.

15. The image forming apparatus according to claim 9,
wherein the controller is configured to calculate the primary transfer voltage according to a transformation formula that transforms the electric current value detected by the primary transfer electric current detector to the primary transfer voltage.

16. The image forming apparatus according to claim 9,
wherein the image density detector includes an optical sensor.

17. An image forming method comprising:
resetting a counter value counted from start of usage of an intermediate transferor;
detecting an electric current value of an electric current supplied to a first primary transferor;
calculating a primary transfer voltage to be applied to the first primary transferor and a second primary transferor based on the detected electric current value;
starting printing;
finishing printing;
detecting the electric current value of the electric current supplied to the first primary transferor; and
calculating the primary transfer voltage to be applied to the first primary transferor and the second primary transferor based on the detected electric current value.

18. The image forming method according to claim 17, further comprising performing a process control after printing finishes.
